(19) United States
(12) Patent Application Publication
(10) Pub. No.: US 2023/0367880 A1
(43) Pub. Date: Nov. 16, 2023

(54) DYNAMIC SELF-CHECK

(71) Applicant: MICRO FOCUS LLC, Santa Clara, CA (US)

(72) Inventors: Gosukonda Naga Venkata Satya Sudhakar, Bangalore (IN); Michael F. Angelo, Houston, TX (US)

(73) Assignee: MICRO FOCUS LLC, Santa Clara, CA (US)

(21) Appl. No.: 17/744,413

(22) Filed: May 13, 2022

(51) Int. Cl. G06F 21/57

(52) U.S. Cl. CPC G06F 21/577; G06F 2221/034

(57) ABSTRACT

A self-contained validation process is initiated. For example, an application may contain code to initiate the self-contained validation process. The self-contained validation process comprises at least one of: a self-contained application validation process, a self-contained container validation process, a self-contained virtual machine validation process, and a self-contained hypervisor validation process. In response to initiating the self-contained validation process, the self-contained validation process requests a list of vulnerabilities associated with the self-contained validation process. The list of vulnerabilities associated with the self-contained validation process is received. For example, the received list of vulnerabilities may identify a security vulnerability in the application. An action taken based on the received list of vulnerabilities associated with the computer process. For example, the application may self-quarantine itself based on the received list of vulnerabilities.

### FIELD

The disclosure relates generally to application/system security and particularly to dynamic application/system security.

### BACKGROUND

When a software application is released, developers try and identify and fix any known vulnerabilities. However, over time, new vulnerabilities may be identified that were preexisting in the software application and were unknown at the time of release. A user of the application may be unaware of these vulnerabilities, which may lead to problems like a security breach of the user's computer/computer network.

### SUMMARY

These and other needs are addressed by the various embodiments and configurations of the present disclosure. The present disclosure can provide a number of advantages depending on the particular configuration. These and other advantages will be apparent from the disclosure contained herein.

A self-contained validation process is initiated. For example, an application may contain code to initiate the self-contained validation process. The self-contained validation process comprises at least one of: a self-contained application validation process, a self-contained container validation process, a self-contained virtual machine validation process, and a self-contained hypervisor validation process. In response to initiating the self-contained validation process, the self-contained validation process requests a list of vulnerabilities associated with the self-contained validation process. The list of vulnerabilities associated with the application (and or components within the application) is received by the self-contained validation process. For example, the received list of vulnerabilities may identify a security vulnerability in the application or a component in the application. Actions [can be/are] taken based on the received list of vulnerabilities associated with the computer process. For example, the application may self-quarantine itself based on the received list of vulnerabilities.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 1.12(f) and/or Section 112 Paragraph 6. Accordingly, a claim incorporating the term “means” shall cover all structures, materials. or ads set forth herein. and all the equivalents thereof. Further, the structures, materials or acts and the equivalents thereof shall include all those described in the summary, brief description of the drawings, detailed description, abstract, and claims themselves.

As described herein an in the claims, the term “self-contained” refers to a process that is self-contained and created directly from within an application, a container, a virtual machine, and/or a hypervisor. For example, in a self-contained application, a self-contained container, a self-contained virtual machine, and a self-contained hypervisor the application/container/virtual machine/hypervisor itself does a vulnerability check. A self-contained validation process may use other files, such as a library(s) and/or a configuration file(s). Self-contained does not refer to external applications/processes. For example, a traditional virus scanner is not a self-contained application because it is a separate application that scans other applications.

The terms “initiate”, “initiating”, and/or the like, when referring to a self-contained validation process as described herein can be or may include loading, starting a thread, starting a process, starting an application, creating/starting a micro service for a container/virtual machine/hypervisor, and/or the like. Initiate may include starting a process before starting an application, such as a container micro service that checks a container docker file before the container is loaded and executed.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for providing a dynamic self-check.

FIG. 2 is a block diagram of an exemplary hierarchy of a self-contained validation process in a communication device.

FIG. 3 is a flow diagram of a process for providing a dynamic self-check.

FIG. 4 is a flow diagram of a process for determining a list of components for a dynamic self-check.

FIG. 5 is a flow diagram of a process for using rules to identify action(s) based on vulnerabilities.

FIG. 6 is a flow diagram of a how vulnerabilities are identified in a vulnerabilities database.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

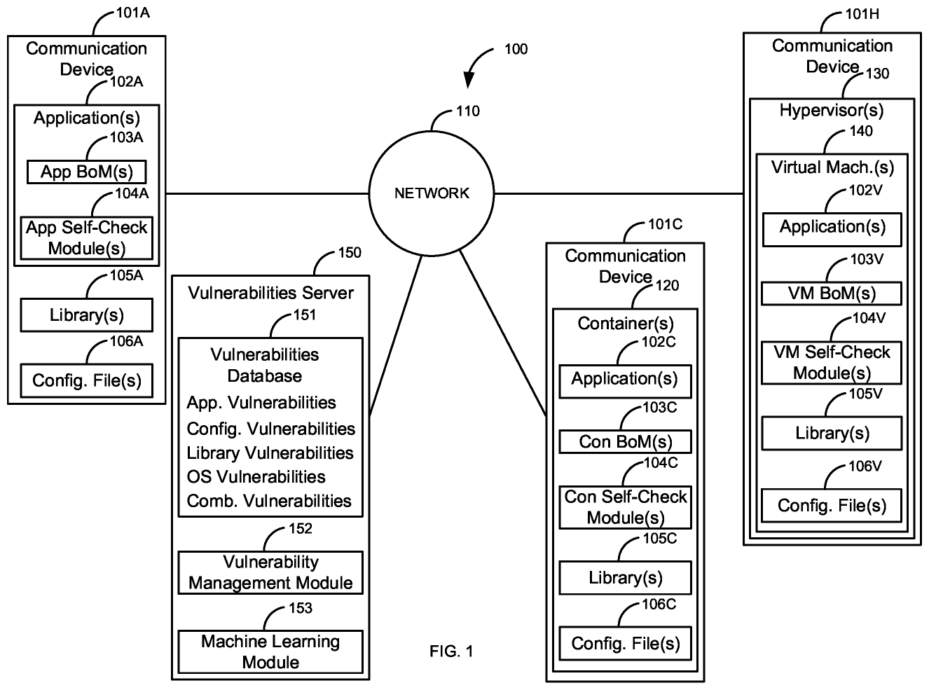

FIG. 1 is a block diagram of a first illustrative system 100 for providing a dynamic self-check. The first illustrative system 100 comprises communication devices 101A, 101C, and 101H, a network 110, and a vulnerabilities server 150.

The communication devices 101A, 101C, and 101H can be or may include any device that can communicate on the network 110, such as a Personal Computer (PC), a telephone, a video system, a cellular telephone, a Personal Digital Assistant (PDA), a tablet device, a notebook device, a smartphone, a server, a cloud service, a web server, an application server, a sensor, an embedded device, and/or the like. Any number of communication devices 101 may be connected to the network 110.

The communication device 101A comprises application(s) 102A, library(s) 105A, and configuration file(s) 106A. The designation “A” on each element 102A-106A indicates that the element 102A-106A is associated with the application(s) 102A. The application(s) 102A can be or may include any application, such as, a web application, a computer application, a financial application, a security application, a document processing application, a network application, a spreadsheet, an email application, a communication application, a sensor application, an embedded application, a database, and/or the like. The application 102A comprises an application bill-of-materials 103A and an application self-check module 104A.

The application bill-of-materials 103A is a list of components that the application 102A uses as part of the execution of the application 102A. There is typically one bill-of-materials 103 for one application 102. The application bill-of-materials 103A may include components that are part of the application (e.g., open-source components/application components), the library(s) 105A (e.g., a dynamic link library (DLL)), the configuration files 106A, and/or the like. In some embodiments, there may not be an application bill-of-materials 103A. For example, the application 102A may be a self-contained executable that does not have an application bill-of-materials 103A.

The application self-check module 104A is a process that is generated from within the application 102A. For example, the application self-check module 104A is part of the code/binaries of the application 102A. Typically, each application 102 will have its own self-check module 104. For example, when the application 102A is first executed, the application self-check module 104A may be a self-contained thread that is invoked before the rest of the application 102A is loaded/executed. The application self-check module 104A uses the application bill-of-materials 103A to get any known vulnerabilities associated with the components in the bill-of-materials 103A by inquiring the vulnerabilities database 151.

The library(s) 105A may be any library 105 that is used by the application(s) 102A. For example, the library(s) 105A may be a DLL, a Java class library, a static library, a dynamic library, an object library, a shared library, and/or the like.

The configuration file(s) 106A may be files that are used by the application(s) 102A that define rules on how the application(s) 102A works. For example, the configuration file 106A may define rules for users of the application 102A, startup parameters, ports blocked on a firewall, and/or the like. The configuration files 106A may be a cause of a vulnerability of in application 102A. For example, setting a particular parameter to a specific value in the configuration file 106A may cause a login vulnerability in a security application 102A.

The communication device 101C comprises a container(s) 120. The designation “C” on each element 102C-106C indicates that the element 102C-106C is associated with the container(s) 120. The container(s) 120 may be any type of container, such as, a Docker container, a Linux (LXC) container, a Container Run-time Interface CRI-O container, a rocket (rkt) container, a Podman container, a runtime container (runc), and/or the like. The container(s) 120 comprises application(s) 102C, container bill-of-material(s) 103C, container self-check module(s) 104C, library(s) 105C, and configuration file(s) 106C.

The container 120 uses the container self-check module 104C in a similar manner as the application self-check module 104A. However, the container self-check module 104C uses the contents of the container 120 (e.g., application(s) 102C, con-bill-of-material(s) 103C, library(s) 105C, and configuration file(s) 106C) to check for vulnerabilities. For example, the container self-check module 104C will check a docker image to get the bill-of-materials 103C. The docker image may comprise one or more applications 102C. Using the bill-of-materials 103C, the container self-check module 104C gets a list of vulnerabilities for the elements of the container 120 before executing the application(s) 102C in the container 120. Typically, there is only one container self-check module 104C for each container 120.

The communication device 101H comprises a hypervisor(s) 130. The hypervisor(s) 130 can be or may include any hardware coupled with software that can be used to host the virtual machine(s) 140. The hypervisor(s) 130 may be a type one hypervisor 130 that runs directly on the communication 101H's hardware, a type two hypervisor 130 that runs on a host operating system, and/or the like.

The hypervisor(s) 130 comprises virtual machine(s) 140. The virtual machine(s) 140 can be or may include any type of virtual machine 140. The virtual machine(s) 140 comprises application(s) 102V, virtual machine bill-of-materials 103V, virtual machine self-check module 104V, library(s) 105V, and configuration files 106V. The designation “V” on each element 102V-106V indicates that the element 102V-106V is associated with the virtual machine(s) 140. When a virtual machine 140 is initially loaded, the virtual machine self-check module 104V uses the virtual machine bill-of-materials 103V to get the list of vulnerabilities for the components of the virtual machine 140 before executing the application(s) 102V in the virtual machine 140. For example, the virtual machine bill-of-materials 103V may comprise the application(s) 102V, the library(s) 105V, the configuration files 106V, hardware components, firmware components, virtual machine components, and/or the like.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The vulnerabilities server 150 can be any server that can be used to provide vulnerability information, such as, a database server, an application server, a corporate server, a cloud service, and/or the like. The vulnerabilities server 150 further comprises a vulnerabilities database 151, a vulnerability management module 152, and a machine learning module 153. The vulnerabilities database 151 is a dynamic database that gets updated regularly as new vulnerabilities are learned about the application(s) 102, the library(s) 105, configurations, container(s) 120, hypervisor(s) 130, virtual machine(s) 140, and/or the like. For example, if it is learned that a library 105 has a newly found security vulnerability, the vulnerabilities database 151 can be updated to include information about the security vulnerabilities in the library 105. Likewise, if a specific configuration of a firewall (e.g., specific ports are open) can cause a security breach of a network 110, the issue can be updated and stored in the vulnerabilities database 151.

The vulnerability management module 152 can be any hardware coupled with software that can manage the vulnerabilities database 151. The vulnerability management module 152 receives a list of components/configuration files 106 (or portions of the configuration file 106), searches the vulnerabilities database 151, and then provides a list of vulnerabilities to the communication device 101. The vulnerability management module 152 also manages the updating process for vulnerabilities associated with the components/configuration.

The machine learning module 153, is used to identify, by learning over time, candidates (e.g., application(s) 102, container(s) 120, hypervisor(s) 130, virtual machine(s) 140, etc.) that may need higher escalation. For example, the machine learning module 153, may identify that a particular application 102 needs to self-quarantine. The machine learning module 153 may also do the opposite and deescalate an issue. For example, the machine learning module 153 may learn over time that a self-quarantine is no longer necessary for the particular application 102.

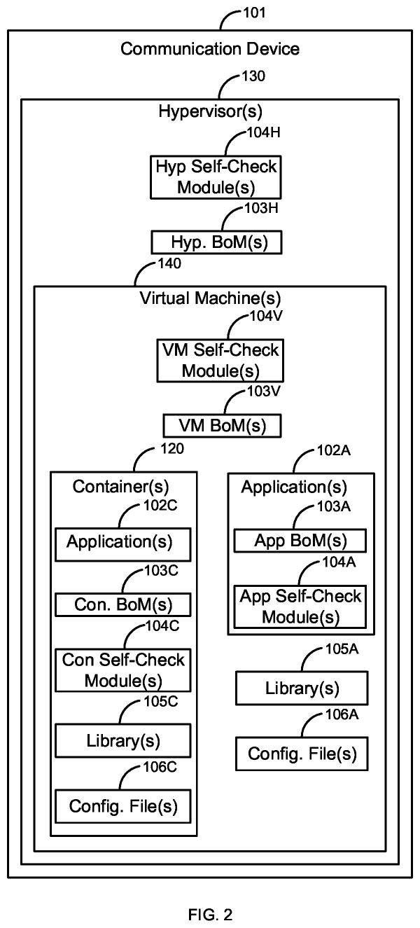

FIG. 2 is a block diagram of an exemplary hierarchy of a self-contained validation process in a communication device 101. The communication device 101 comprises the hypervisor(s) 130. The hypervisor(s) 130 comprises a hypervisor self-check module 104H, a hypervisor bill-of-materials 103H, and one or more virtual machines 140. The designation “H” on the elements 103H/104H indicates that the elements 103H/104H are associated with the virtual machine(s) 140. The hypervisor self-check module 104H is used to check components/configurations associated with the hypervisor 130 based on the hypervisor bill-of-materials 103H. For example, the hypervisor bill-of-materials 103H may identify the hypervisor 130 (e.g., version number), an operating system used by the hypervisor (e.g., a type two hypervisor 130), drivers used by the hypervisor 130 (e.g., network card drivers, disk drivers, and/or printer drivers), and/or the like.

The virtual machine(s) 140 comprise the virtual machine self-check module(s) 104V, the virtual machine bill-of-material(s) 103V, container(s) 120, application(s) 102A, library(s) 105A, and configuration file(s) 106A. While FIG. 2 shows both application(s) 102A and container(s) 120 running on a virtual machine 140, other embodiments may only have the container(s) 120 or the application(s) 102A/library(s) 105A/configuration file(s) 106A.

The virtual machine self-check module 104V uses the virtual machine bill-of-materials 103V to check components/configuration for vulnerabilities by accessing the vulnerabilities database 151. For example, the virtual machine bill-of-materials 103V may identify an operating system (e.g., version number) used by each virtual machine 130, driver(s) (e.g., a version number) used by the operating system in each virtual machine 140, and/or the like.

The container(s) 120 are like the container(s) 120 of FIG. 1. The container(s) 120 comprises application(s) 102C, container bill-of-material(s) 103C, container self-check module(s) 104C, library(s) 105C, and the configuration file(s) 106C. The container self-check module(s) 104C work like the container self-check module 104C described in FIG. 1. Likewise, the application(s) 102A, the application bill-of-material(s) 103A, the application self-check module(s) 104A, the library(s) 105A, and the configuration file(s) 106A work in a similar manner as described in FIG. 1.

The hierarchy of self-contained validation process in FIG. 2 are as follows: 1) self-contained hypervisor validation process at a top level, 2) the self-contained virtual machine validation process at a second level, and 3) the self-contained container validation process and/or the self-contained application validation process at the third level.

As one can see, there may be various hierarches of self-contained validation processes that can be envisioned based on the description of FIGS. 1-2. Other examples may include: 1) the self-contained hypervisor validation process at the top level, the self-contained virtual machine validation process at the second level, and the self-contained container validation process and the self-contained application validation process at the third level; 2) the self-contained hypervisor validation process at the top level, the self-contained virtual machine validation process at the second level; 3) the self-contained virtual machine validation process at the first level, and the self-contained application validation process at the second level; 4) the self-contained virtual machine validation process at the first level, and the self-contained container validation process at the second level; 5) the self-contained virtual machine validation process at the first level, and the self-contained container validation process and the self-contained application validation process at the second level; 6) the self-contained container validation process at the top level and the self-contained application validation process at the second level, and/or the like.

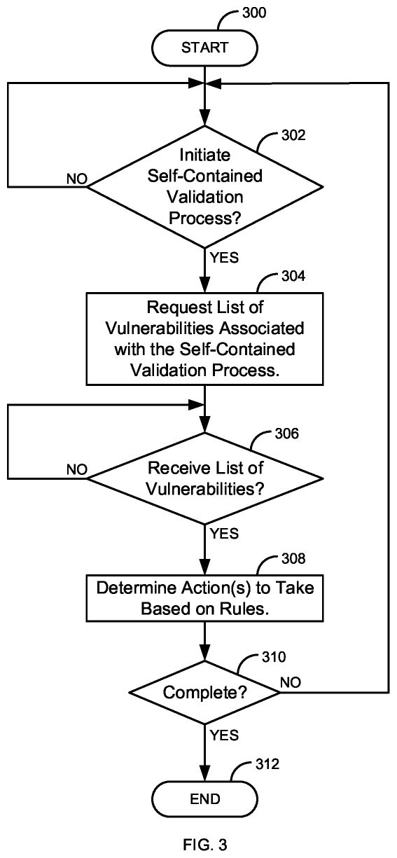

FIG. 3 is a flow diagram of a process for providing a dynamic self-check. Illustratively, the communication devices 101A, 101C, and 101H, the application(s) 102A, the application self-check module(s) 104A, the library(s) 105A, the container(s) 120, the application(s) 102C, the container self-check module(s) 104C, the library(s) 105C, the hypervisor(s) 130, the virtual machine(s) 140, the application(s) 102V, the virtual machine self-check module(s) 104V, the libraries 105V, the hypervisor self-check module(s) 104H are stored-program-controlled entities, such as a computer or microprocessor, which performs the method of FIGS. 3-6 and the processes described herein by executing program instructions stored in a computer readable storage medium, such as a memory (i.e., a computer memory, a hard disk, and/or the like). Although the methods described in FIGS. 3-6 are shown in a specific order, one of skill in the art would recognize that the steps in FIGS. 3-6 may be implemented in different orders and/or be implemented in a multi-threaded environment. Moreover, various steps may be omitted or added based on implementation.

The process starts in step 300. The self-check module (104A, 104C, 104V, and/or 104H) waits to initiate a self-contained validation process in step 302. The initiation of the self-contained validation process may be when the process (e.g., the application 102, the container 120, the hypervisor 130 and the virtual machine 140) is first initiated. In addition, initiation of the self-contained validation process may occur after the process starts. For example, a thread may periodically initiate the self-contained application validation process after an application 102 has been loaded. If a self-contained validation process is not initiated in step 302, the process of step 302 repeats.

Otherwise, if the self-contained validation process has been initiated in step 302, the self-check module 104 requests, in step 304, a list of vulnerabilities associated with the self-contained process from the vulnerabilities server 150. The list of vulnerabilities indicates various types of vulnerabilities associated with the application(s) 102, the library(s) 105, the config file(s) 106, the container(s) 120, the hypervisor(s) 130, the virtual machine(s) 140, and/or the like. The list of vulnerabilities may be in various formats, such as, eXtended Markup Language (XML), text, number representations of vulnerabilities, tokens indicating a vulnerability, and/or the like. The self-check module 104 waits, in step 306, to receive the list of vulnerabilities from the vulnerabilities server 150. If the list of vulnerabilities has not been received in step 306, the process waits in step 306 (or possibly times out). If the list of vulnerabilities has been received in step 306, the self-check module 104 determines, in step 308, any actions to take based on rules.

The self-check module 104 determines, in step 310, if the process is complete. If the process is not complete in step 310, the process goes back to step 302. Otherwise, if the process is complete in step 310, the process ends in step 312.

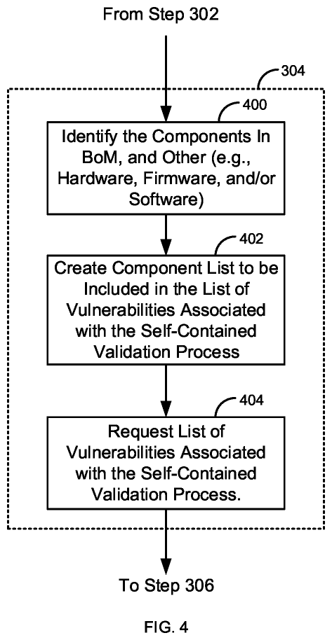

FIG. 4 is a flow diagram of a process for determining a list of components for a dynamic self-check. FIG. 4 is an exemplary embodiment of step 304 of FIG. 3. After initiating the self-contained validation process in step 302, the self-check module 104 identifies components that are associated in the associated bill-of-materials 103 in step 400. For example, if the self-check module 104 is the container self-check module 104C, the container self-check module 104C will get the container bill-of-materials 103C in step 400. The bill-of-materials 103 may identify software components (e.g., application 102, library(s) 105, operating systems, drivers, hypervisor components, virtual machine components, container components, etc.), configuration files 106, and/or the like.

The self-check module 104 may also identify other components, such as, hardware components (e.g., a network card, a disk drive), firmware (e.g., Basic Input Output System (BIOS) versions), and/or the like. For example, there may be vulnerabilities associated with combinations of software, firmware, and/or hardware in step 400. The self-check module 104 may also identify the configuration files 106 in step 400.

The self-check module 104 creates a list of components/configuration files 106 to be included in the request for the list of vulnerabilities associated with the self-contained validation process in step 402. The self-check module 104 requests, from the vulnerabilities server 150, the list of vulnerabilities associated with the self-contained validation process in step 404. The process then goes to step 306 to wait to receive the list of vulnerabilities.

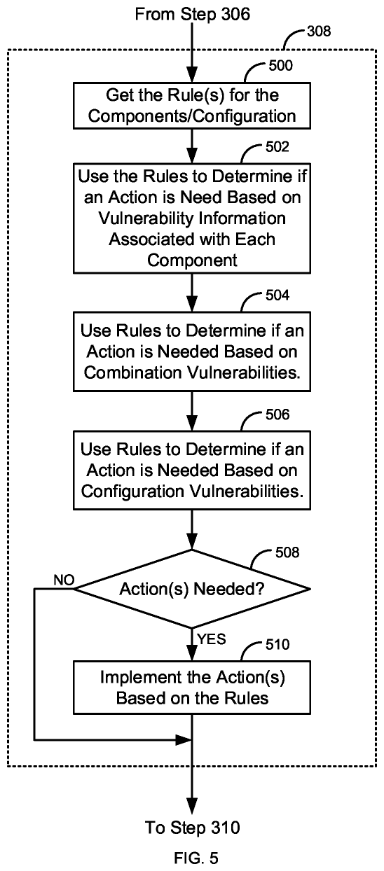

FIG. 5 is a flow diagram of a process for using rules to identify action(s) based on vulnerabilities. FIG. 5 is an exemplary embodiment of step 308 of FIG. 3. After receiving the list of vulnerabilities in step 306, the self-check module 104 gets the rule(s) for the components/configuration in step 500. The rules may be defined in various places/ways, such as, in in the self-contained validation process (e.g., pre-configured when the self-check module 104 starts), in the received list of vulnerabilities associated with the self-contained validation process (e.g., rules defined by the vulnerability management module 152), in a configuration file 106 (e.g., locally administered), and/or the like. The rules in the received list of vulnerabilities may be dynamically changed based on machine learning. For example, the machine learning module 153 may learn that a vulnerability for a configuration file 106 is more of a security threat than previously determined. In this example, the machine learning module 153 may increase a vulnerability ranking for the configuration file 106.

The self-check module 104 uses the rules to determine if an action is need based on the vulnerability information associated with each component in step 502. For example, list of vulnerabilities may identify where the application 102A can crash if it is in a specific state and identify a security issue with a library 105A. A similar process will work for container self-check module 104C, the virtual machine self-check module 104V, and the hypervisor self-check module 104H. For example, the list of vulnerabilities may indicate a memory allocation issue with an operating system associated with the virtual machine 140.

The self-check module 104 uses the rules to determine if an action is needed based on a combination vulnerability in step 504. A combination vulnerability is where two specific components together cause a vulnerability. The combination may be two or more of: an individual vulnerability associated with the self-contained validation process, a library vulnerability, a configuration vulnerability, a hardware vulnerability, a firmware vulnerability, and an operating system vulnerability, and/or the like. For example, there may be a vulnerability based on a combination of a specific version of an operating system and specific version of network interface card or a specific application version 102A and a specific library 105A version.

The self-check module 104 uses the rules to determine, in step 506, if an action is needed based on configuration vulnerabilities. For example, a configuration vulnerability may be where a configuration file 106A for a firewall (106A) is configured to have all in-bound ports open. The vulnerability may be that the network 110 not properly protected.

The self-check module 104 determines, in step 508, if one or more actions are need based on the identified vulnerabilities. The action may be to self-quarantine (e.g., self-quarantine a container 120), add an entry to one or more records, notify a user, modify a configuration file 106, download and install a patch, download and install a new version of an application, download and install a new version of a component (e.g., from the vulnerabilities server 150), and/or the like.

The determination in step 508 may be based on a threshold or a level defined in the list of vulnerabilities received from the vulnerabilities server 150. For example, the vulnerability for each component/configuration/combination may have a rating of how severe the vulnerability is (e.g., 1-10 where 10 is the highest). The rules may define that any vulnerability will be logged, any vulnerability over two will warrant a notification to an administrator, and any vulnerability over six will cause a self-quarantine (e.g., not load a virtual machine 140). Patching/downloading may also have separate rules to determine when/if the download/patch is going to occur. There may be rules may be different based on if the vulnerability process is just being initialized or if the application 102/container 102/ hypervisor 130/virtual machine 140 is already running.

If an action is not needed in step 508, the process goes to step 310. Otherwise, if an action is needed in step 508, the action(s) are implemented based on the rules and the process goes to step 310.

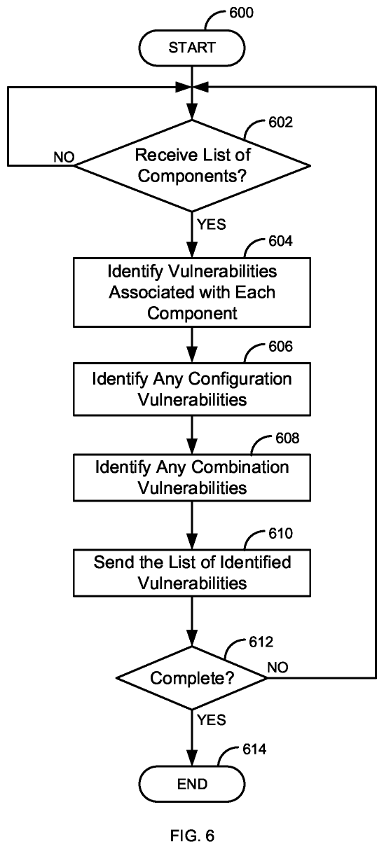

FIG. 6 is a flow diagram of a how vulnerabilities are identified in a vulnerabilities database 151. The process starts in step 600. The vulnerability management module 152 waits, in step 602, to receive the list of components. If the list of components is not received in step 602, the process of step 602 repeats.

If the list of components is received in step 602, the vulnerability management module 152 identifies vulnerabilities associated with each component in step 604. For example, there may be a vulnerability associated with a specific version of an operating system driver and a specific version of a hypervisor 130. The vulnerability management module 152 identifies any configuration vulnerabilities in step 606. For example, the list of components received in step 602 may also comprise a configuration file 106 (or part of the configuration file 106). A configuration vulnerability may be where setting a specific parameter in the configuration file 106 to a specific value can cause the application 102A to randomly crash.

The vulnerability management module 152 identifies any combination vulnerabilities in step 608. A combination vulnerability may be where a specific version of disk drive is incompatible with a specific version of a disk driver. The vulnerability management module 152 sends, in step 610, the list of identified vulnerabilities to the self-check module 104.

The vulnerability management module 152 determines, in step 612, if the process is complete. If the process is not complete in step 612, the process goes to step 602. Otherwise, if the process is complete in step 612, the process ends in step 614.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
initiate a self-contained validation process, wherein the self-contained validation process comprises at least one of: a self-contained application validation process, a self-contained container validation process, a self-contained virtual machine validation process, and a self-contained hypervisor validation process;
in response to initiating the self-contained validation process, request, by the self-contained validation process, a list of vulnerabilities associated with the self-contained validation process;
receive the list of vulnerabilities associated with the self-contained validation process; and
take an action based on the received list of vulnerabilities associated with the computer process.

2. The system of claim 1, wherein the action is to one or more of: self-quarantine, add an entry to one or more records, notify a user, modify a configuration file, download and install a patch, download and install a new version of an application, and download and install a new version of a component.

3. The system of claim 1, wherein requesting the list of vulnerabilities associated with the self-contained validation process further comprises requesting the list of vulnerabilities associated with the self-contained validation process after the self-contained validation process is loaded.

4. The system of claim 1, wherein the list of vulnerabilities associated with the self-contained validation process comprises one or more of: application vulnerabilities, configuration vulnerabilities, library vulnerabilities, operating system vulnerabilities, hypervisor vulnerabilities, container vulnerabilities, virtual machine vulnerabilities, and combination vulnerabilities.

5. The system of claim 1, wherein the action is taken based on one or more rules and wherein the one or more rules are defined in in the self-contained validation process, in the list of vulnerabilities associated with the self-contained validation process, and/or in a configuration file.

6. The system of claim 1, wherein the action taken is based on a combination vulnerability that comprises at least two of: an individual vulnerability associated with the self-contained validation process, a library vulnerability, a configuration vulnerability, a hardware vulnerability, a firmware vulnerability, a driver vulnerability, and an operating system vulnerability.

7. The system of claim 1, wherein the self-contained validation process uses a self-contained bill-of-materials, wherein the self-contained bill-of-materials comprises a plurality of components and wherein the request for the list of vulnerabilities associated with the self-contained validation process requests an individual list of vulnerabilities for each of the plurality of components in the self-contained bill-of-materials.

8. The system of claim 1, wherein the self-contained validation process comprises a hierarchy of self-contained validation processes.

9. The system of claim 8, wherein the hierarchy of self-contained validation processes comprises one of:
the self-contained hypervisor validation process at a top level, the self-contained virtual machine validation process at a second level, and the self-contained container validation process at a third level;
the self-contained hypervisor validation process at the top level, the self-contained virtual machine validation process at the second level, and the self-contained application validation process at the third level;
the self-contained hypervisor validation process at the top level, the self-contained virtual machine validation process at the second level, and the self-contained container validation process and the self-contained application validation process at the third level;
the self-contained hypervisor validation process at the top level and the self-contained virtual machine validation process at the second level;
the self-contained virtual machine validation process at the first level and the self-contained application validation process at the second level;
the self-contained virtual machine validation process at the first level and the self-contained container validation process at the second level;
the self-contained virtual machine validation process at the first level, and the self-contained container validation process and the self-contained application validation process at the second level; and
the self-contained container validation process at the top level and the self-contained application validation process at the second level.

10. The system of claim 1, wherein requesting the list of vulnerabilities associated with the self-contained validation process comprises sending a configuration file or at least some content of the configuration file to a vulnerabilities server and wherein the vulnerabilities server determines if there are any configuration vulnerabilities based the configuration file or the at least some content of the configuration file.

11. A method comprising:
initiating a self-contained validation process, wherein the self-contained validation process comprises at least one of: a self-contained application validation process, a self-contained container validation process, a self-contained virtual machine validation process, and a self-contained hypervisor validation process;
in response to initiating the self-contained validation process, requesting, by the self-contained validation process, a list of vulnerabilities associated with the self-contained validation process;
receiving the list of vulnerabilities associated with the self-contained validation process; and
taking an action based on the received list of vulnerabilities associated with the computer process.

12. The method of claim 11, wherein the action is to one or more of: self-quarantine, add an entry to one or more records, notify a user, modify a configuration file, download and install a patch, download and install a new version of an application, and download and install a new version of a component.

13. The method of claim 11, wherein requesting the list of vulnerabilities associated with the self-contained validation process further comprises requesting the list of vulnerabilities associated with the self-contained validation process after the self-contained validation process is loaded.

14. The method of claim 11, wherein the list of vulnerabilities associated with the self-contained validation process comprises one or more of: application vulnerabilities, configuration vulnerabilities, library vulnerabilities, operating system vulnerabilities, hypervisor vulnerabilities, container vulnerabilities, virtual machine vulnerabilities, and combination vulnerabilities.

15. The method of claim 11, wherein the action taken is based on a combination vulnerability that comprises at least two of: an individual vulnerability associated with the self-contained validation process, a library vulnerability, a configuration vulnerability, a hardware vulnerability, a firmware vulnerability, a driver vulnerability, and an operating system vulnerability.

16. The method of claim 11, wherein the self-contained validation process uses a self-contained bill-of-materials, wherein the self-contained bill-of-materials comprises a plurality of components and wherein the request for the list of vulnerabilities associated with the self-contained validation process requests an individual list of vulnerabilities for each of the plurality of components in the self-contained bill-of-materials.

17. The method of claim 11, wherein the self-contained validation process comprises a hierarchy of self-contained validation processes.

18. The method of claim 17, wherein the hierarchy of self-contained validation processes comprises one of:
the self-contained hypervisor validation process at a top level, the self-contained virtual machine validation process at a second level, and the self-contained container validation process at a third level;
the self-contained hypervisor validation process at the top level, the self-contained virtual machine validation process at the second level, and the self-contained application validation process at the third level;
the self-contained hypervisor validation process at the top level, the self-contained virtual machine validation process at the second level, and the self-contained container validation process and the self-contained application validation process at the third level;
the self-contained hypervisor validation process at the top level and the self-contained virtual machine validation process at the second level;
the self-contained virtual machine validation process at the first level and the self-contained application validation process at the second level;
the self-contained virtual machine validation process at the first level and the self-contained container validation process at the second level;
the self-contained virtual machine validation process at the first level, and the self-contained container validation process and the self-contained application validation process at the second level; and
the self-contained container validation process at the top level and the self-contained application validation process at the second level.

19. The method of claim 11, wherein requesting the list of vulnerabilities associated with the self-contained validation process comprises sending a configuration file or at least some content of the configuration file to a vulnerabilities server and wherein the vulnerabilities server determines if there are any configuration vulnerabilities based the configuration file or the at least some content of the configuration file.

20. A non-transient computer readable medium having stored thereon
instructions that cause a processor to execute a method, the method comprising: instructions to:
initiate a self-contained validation process, wherein the self-contained validation process comprises at least one of: a self-contained application validation process, a self-contained container validation process, a self-contained virtual machine validation process, and a self-contained hypervisor validation process;
in response to initiating the self-contained validation process, request, by the self-contained validation process, a list of vulnerabilities associated with the self-contained validation process;
receive the list of vulnerabilities associated with the self-contained validation process; and
take an action based on the received list of vulnerabilities associated with the computer process.
